(19) United States
(12) Patent Application Publication
(10) Pub. No.: US 2015/0217143 A1
(43) Pub. Date: Aug. 6, 2015

(54) IN-LINE ACCESSORY FOR A SELF-CONTAINED BREATHING APPARATUS

(71) Applicant: MOTOROLA SOLUTIONS, INC, SCHAUMBURG, IL (US)

(72) Inventors: MARK C. PALMER, ASTORIA, NY (US); JAMES C. KRAUSE, ASTORIA, NY (US); KARTHIK LAKSHMINARAYANAN, WILMINGTON, DE (US)

(73) Assignee: MOTOROLA SOLUTIONS, INC, SCHAUMBURG, IL (US)

(21) Appl. No.: 14/173,444

(22) Filed: Feb. 5, 2014

(51) Int. Cl. A62B 9/04; A62B 18/08; G06F 19/00; A62B 18/02

(52) U.S. Cl. CPC A62B 9/04; A62B 18/02; A62B 18/08; G06F 19/3418

(57) ABSTRACT

An in-line accessory (10) for use with a self-contained breathing apparatus (SCBA) system (12) and associated method include a hardware form factor comprising an opening (42); a first connection interface (30) on the hardware form factor configured to selectively connect with a connection interface on a regulator (16) of the SCBA system (12); a second connection interface (32) on the hardware form factor configured to selectively connect with a connection interface on a mask (14) of the SCBA system (12); and circuitry disposed on and/or within the hardware form factor to perform and add one or more functions to the SCBA system (12); wherein the hardware form factor is disposed between the regulator (16) and the mask (14) in a non-obtrusive manner in the SCBA system (12) and the opening (42) supports air flow from the regulator (16) to the mask (14).

### BACKGROUND OF THE INVENTION

A self-contained breathing apparatus (SCBA), sometimes referred to as a compressed air breathing apparatus (CABA), air-pack, or simply breathing apparatus (BA), is a device worn by rescue workers, firefighters, and others to provide breathable air in an IDLH (immediate danger to life and health) atmosphere. When not used underwater, they are sometimes called industrial breathing sets. The term “self-contained” means that the breathing set is not dependent on a remote supply (e.g., through a long hose). If designed for use under water, the apparatus is called SCUBA (self-contained underwater breathing apparatus). A SCBA typically has three main components: a high-pressure tank, a pressure regulator, and an inhalation connection (mouthpiece, mouth mask or face mask), connected together and mounted to a carrying frame.

With conventional SCBA, such as with firefighters, one of the most noticeable problems is attempting to locate equipment features (i.e., air tank regulators, radios, remote speaker microphones (RSMs), etc.) while in high stress, low visibility, and low dexterity situations. There is also a general lack of integration of these equipment which only adds to the difficulty. With respect to conventional RSM use with SCBA, there are interaction, ergonomic, wearability, and device management challenges that users experience with current RSMs and other audio devices. Furthermore, for rescue workers, firefighters, or other working in hazardous environments, when a person is injured or incapacitated, it can be difficult for them to communicate their situation to others. Complex and restrictive respiration gear can further compound the problem. Further, there are almost no unobtrusive methods currently available to detect an injury or incapacitation and automatically communicate this information to others. The specialized gear that workers in hazardous environments must wear limits solutions. Additionally for these persons there are no unobtrusive methods currently available to predict potential health hazards such as, dehydration, dangerously high blood pressure, disorientation, etc.

Systems and products that currently exist are not adequately located on the body. Life-monitoring systems should ideally be placed at the users head/face so that sensor information is closely coupled to the bodily features that communicate their vital status (breath, eyes, head position, head temp)

Accordingly, there is a need for an in-line accessory for a self-contained breathing apparatus (SCBA) addressing the aforementioned limitations.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a perspective diagram of an in-line accessory that is coupled to a SCBA system in accordance with some embodiments.

FIG. 2 is a perspective diagram of the SCBA system of FIG. 1 with the in-line accessory disconnected in accordance with some embodiments.

FIG. 3 is a perspective diagram of the SCBA system of FIGS. 1-2 with the in-line accessory connected in accordance with some embodiments.

FIG. 4 is a perspective diagram of the SCBA system of FIGS. 1-3 illustrating connecting the in-line accessory to the mask and the regulator in accordance with some embodiments.

FIG. 5 is a perspective diagram of manual locking the in-line accessory to the mask in accordance with some embodiments.

FIG. 6 is a perspective diagram of manual locking the in-line accessory to the regulator in accordance with some embodiments.

FIG. 7 is a schematic diagram of the in-line accessory as a remote speaker microphone (RSM) in accordance with some embodiments.

FIG. 8 is a diagram of a user operating the in-line accessory as an RSM with PTT activation in accordance with some embodiments.

FIG. 9 is a schematic diagram of the in-line accessory as a biometric sensor and the like in accordance with some embodiments.

FIG. 10 is a block diagram of an electrical architecture of the in-line accessory as a sensor in accordance with some embodiments.

FIG. 11 is a flowchart of an in-line accessory method for integration with a self-contained breathing apparatus (SCBA) system in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In an exemplary embodiment, an in-line accessory (10) for use with a self-contained breathing apparatus (SCBA) system (12) includes a hardware form factor comprising an opening (42); a first connection interface (30) on the hardware form factor configured to selectively connect with a connection interface on a regulator (16) of the SCBA system (12); a second connection interface (32) on the hardware form factor configured to selectively connect with a connection interface on a mask (14) of the SCBA system (12); and circuitry disposed on and/or within the hardware form factor to perform and add one or more functions to the SCBA system (12); wherein the hardware form factor is disposed between the regulator (16) and the mask (14) in a non-obtrusive manner in the SCBA system (12) and the opening (42) supports air flow from the regulator (16) to the mask (14).

In another exemplary embodiment, a self-contained breathing apparatus (SCBA) system (12) includes a mask (14) comprising a first connection interface (20); a regulator (16) comprising a second connection interface (18), wherein the first connection interface (20) is configured to connect with the second connection interface (18); and an in-line accessory (10) comprising a third connection interface (32) configured to selectively connect with the first connection interface (20) and a fourth connection interface (30) configured to selectively connect with the second connection interface (18), wherein the in-line accessory (10) is selectively disposed between the mask (14) and the regulator (16) to add one or more functions to the SCBA system (12), wherein air flows between the regulator (16) and the mask (14) via an opening (42) in the in-line accessory; wherein the in-line accessory (10) is disposed between the regulator (16) and the mask (14) in a non-obtrusive manner in the SCBA system (12).

In yet another exemplary embodiment, an in-line accessory (10) method for integration with a self-contained breathing apparatus (SCBA) system (12) includes providing an in-line accessory (10) comprising a first connection interface (30) configured to selectively connect with a connection interface on a regulator (16) of the SCBA system (12) and a second connection interface (32) configured to selectively connect with a connection interface on a mask (14) of the SCBA system (12); attaching the in-line accessory (10) to the mask (14) via the second connection interface (32); attaching the in-line accessory (10) to the regulator (16) via first connection interface (30); and operating a function through the in-line accessory (10) while using the SCBA system (12); wherein the in-line accessory (10) is disposed between the regulator (16) and the mask (14) in a non-obtrusive manner in the SCBA system (12).

In various exemplary embodiments, an in-line accessory for a self-contained breathing apparatus (SCBA) and associated method are described. The in-line accessory is configured to leverage existing equipment via an in-line configuration between the pressure regulator and the inhalation connection of a SCBA. In an exemplary embodiment, the in-line accessory includes a hardware platform/interface form factor that exploits the twist-mount interface between a Scott Air-Pak regulator and face mask being connected therebetween in-line (in-line meaning that openings on the regulator, facemask, and in-line accessory align such that a straight line can pass through all of the openings, and preferably the straight line can pass through a user's open mouth through the openings). In alternate embodiments of the present invention, the openings may not be in-line. In various exemplary embodiments, the in-line accessory can include, without limitations, biometric sensors, thermal sensors, remote speaker microphones (RSMs), push-to-talk RSMs, heads up display, and the like. Advantageously, the in-line location is a prime location on a user being in position where the user can easily hear, see, speak, or otherwise interact with the in-line accessory, and also an ideal location to capture biometric and environmental data about the worker. Co-locating an environmental or biometric sensor on the firefighters head is ideal

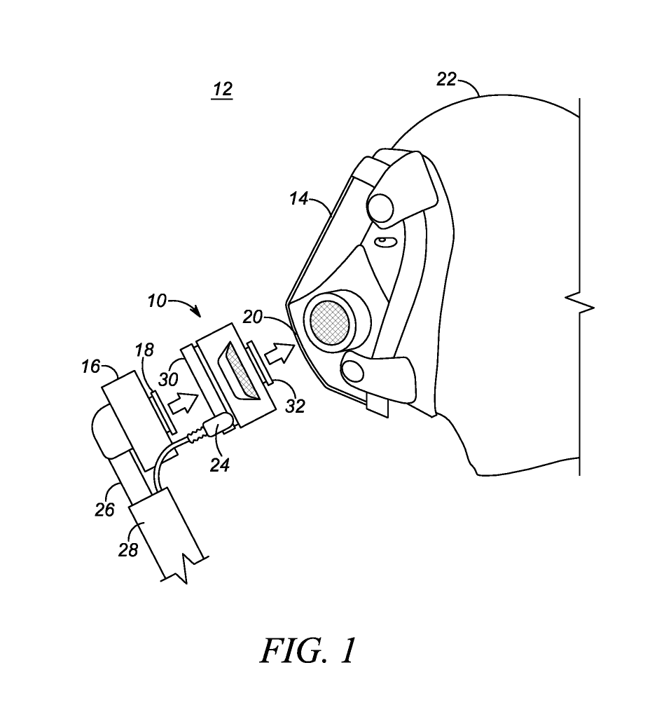

FIG. 1 is a perspective diagram of an in-line accessory 10 that is coupled to a SCBA system 12 in accordance with some embodiments. The SCBA system 12 includes a mask 14 and a regulator 16. The mask 14 and the regulator 16 can be Scott compliant devices. The in-line accessory 10 also contemplates extension/use with other types of SCBA gear from other manufacturers besides Scott. Conventionally, the mask 14 connects to the regulator 16 via a male twist-lock interface 18 on the regulator 16 and a female twist-lock interface 20 on the mask 14. The mask 14 is worn by a user 22 over the user's mouth and nose and the regulator 16 connects to an air supply (not shown) such that air is supplied to the user 22 via the regulator 16 through the mask 14. For example, the female twist-lock interface 20 and the male twist-lock interface 18 include an opening for air-flow therethrough.

In various exemplary embodiments, the in-line accessory 10 includes a puck-like (i.e., hockey puck) form factor that attaches to the standard mating interface of the mask 14 and the regulator 16. The in-line accessory 10 is configured to connect between the mask 14 and the regulator 16 leveraging the female twist-lock interface 20 and the male twist-lock interface 18 for connectivity, including an opening for air-flow between the regulator 16 and the mask, and providing hardware platform/interface form factor for various functions as described herein. Specifically, the in-line accessory 10 leverages the existing twist-mount interface between a Scott-Air-Pak regulator and face mask.

The in-line accessory 10 can include a cable connection 24 for data and/or power that is routed together with an air cable 26 attached to the regulator 16 in a same sheath 28. The cable connection 24 can connect the in-line accessory 10 to an air pack (not shown) or other components. The cable connection 24 is an accessory cord providing connectivity to the in-line accessory 10. The sheath 28 allows the cable connection 24 to be routed with the air cable 26. Alternatively, the cable connection 24 could be routed in a jacket on the user 22. Also, the in-line accessory 10 can include wireless connectivity and on-board power via a battery or the like. Here, the in-line accessory may not need the cable connection 24. The in-lines accessory 10 can also include wireless with the cable connection 24 included as well.

The in-line accessory 10 can provide one or more functions while being mounted and sandwiched between the mask 14 and regulator 16. Thus the in-line accessory 10 is located in front of the user's mouth and in-line with the user's air-flow. In other words, a straight line can be drawn from through the opening of the user's mouth, through the openings of the in-line accessory. This is a prime location for technology on the user 22 due to being in a position where the user 22 can easily hear, see, speak, or otherwise interact with a piece of technology, and also an ideal location to capture biometric and environmental data about the user 22.

In an exemplary embodiment, the user 22 can be a firefighter or the like and the in-line accessory 10 can include an environmental sensor or biometric sensor. Co-locating an environmental sensor or biometric sensor on the firefighter's head is ideal. Here, the location is in-line with the user's air-flow, breathing, etc. and it does not add considerable bulk to the SCBA system 12. Additionally, the user 22 can be a HAZMAT worker, a construction worker, a SCUBA diver, etc. Various functions of the in-line accessory 10 could include, without limitation, a Remote Speaker Microphone (RSM), Biometric Monitoring, Environmental/Temperature Monitoring, Rollover Detection System, Heads Up Display (HUD), Indoor Locationing System, etc.

Advantageously, the in-line accessory 10 leverages existing user equipment rather than adding a new freestanding piece, is positioned/located in a lower field of view of the user 22 where it can be easily viewed/seen, is positioned/located up on the face of the user 22 where it can be reached and interacted with easily, is positioned/located up on the head and in-line with air-flow/breathing of the user 22 where collecting data about the user 22, etc. That is, due to the position/location of the in-line accessory, environmental or biometric data captured at this location would be most relevant to the user's true situation.

The in-line accessory 10 is configured to interface to the mask 14 and the regulator 16. On a side of the in-line accessory 10 facing the regulator 16, the in-line accessory 10 includes an interface that is the same as the interface on the mask 14, and on a side of the in-line accessory 10 facing the mask 14, the in-line accessory 10 includes an interface that is the same as the interface on the regulator 16. Stated differently, the in-line accessory 10 includes a dual-sided interface that is compatible with the associated interfaces on the mask 14 and the regulator 16 to form a compact and integrated device in the SCBA system 12. The in-line accessory 10 also includes a mating surface air seal that seals against the mask 14 and the regulator 16. In this manner, the in-line accessory 10 is fully compatible with the existing interfaces in the SCBA system 12 and requires no special hardware for attachment thereto.

In an exemplary embodiment for a Scott SCBA system, the in-line accessory 10 includes a female twist-lock interface 30 and a male twist-lock interface 32. The female twist-lock interface 30 is configured to interface the male twist-lock interface 18 on the regulator 16, and the male twist-lock interface 32 is configured to interface the female twist-lock interface 20 on the mask 14. In other SCBA systems besides Scott, those of ordinary skill in the art will recognize that other types of interfaces are also contemplated besides the twist-lock interfaces 18, 20, 30, 32. The male twist-lock interface 32, as a connection interface, is substantially the same as the male twist-lock interface 18, as a connection interface, on the regulator 16 and the female twist-lock interface 30, as a connection interface, is substantially the same as the female twist-lock interface 20 on the mask 14 thereby enabling the in-line accessory 10 to connect with the SCBA system 12 without changes to the SCBA system 12.

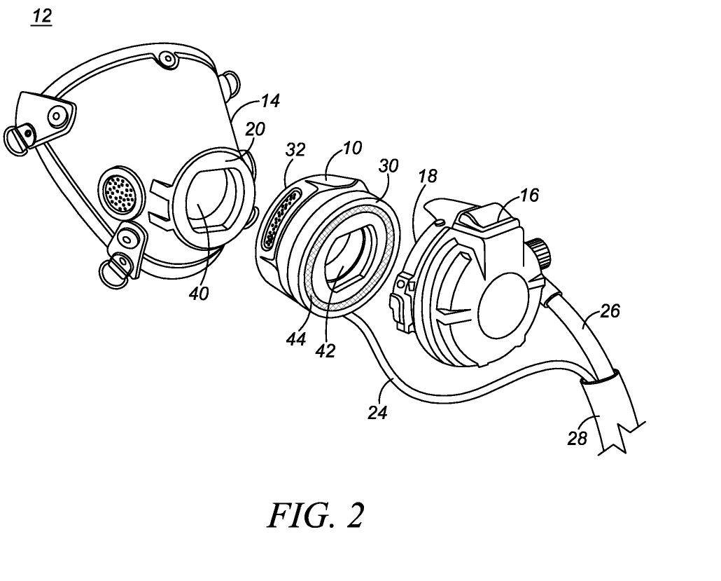

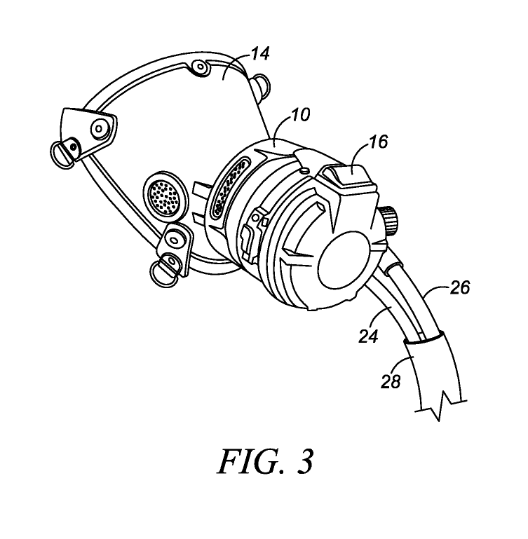

FIGS. 2 and 3 are perspective diagrams of the SCBA system 12 with the in-line accessory 10 disconnected (FIG. 2) and connected (FIG. 3) in accordance with some embodiments. Specifically, FIGS. 2 and 3 illustrate the SCBA system 12 without the user 22. In FIG. 2, the in-line accessory 10 is illustrated separate and disconnected from the mask 14 and the regulator 16, and in FIG. 3, the in-line accessory 10 is illustrated connected to the mask 14 and the regulator 16. The mask 14 includes the female twist-lock interface 20 and an opening 40. Again, conventionally, the regulator 16 connects to the mask 14 through its male twist-lock interface 18 connecting to the female twist-lock interface 20, and the regulator 16 provides air flow from the air cable 26 to the user 22 through the opening 40.

The in-line accessory 10 includes an opening 42 which can be similarly shaped as the opening 40 allowing air flow from the regulator 16 via the air cable 26 to the user 22 through both the openings 40, 42. The in-line accessory 10 can include a substantially cylindrical shape with the opening 42 in a center portion. Again, this gives the in-line accessory 10 a “puck-like” shape. The in-line accessory 10 can include a seal 44 which forms an air-tight barrier between the in-line accessory 10 and the regulator 16 (also, another seal (not shown) can be between the in-line accessory 10 and the mask 14 on the other side). The seal 44 on the in-line accessory 10 forms an air-tight barrier between the in-line accessory 10 and the regulator 16, and another seal (not shown) forms an air-tight barrier between the in-line accessory 10 and the mask 14.

In FIG. 3, in the connected state, the in-line accessory 10 slightly protrudes from the mask 14 adding a small amount of length to the regulator 16. In an exemplary embodiment, the in-line accessory 10 can include a length extending outwards from the mask 14 when connected that is equal to or less than a length of the regulator 16. In this manner, the in-line accessory 10, while being added on, interconnects in an existing manner in an integrated fashion in the SCBA system 12.

The location of the in-line accessory 10 between the mask 14 and the regulator 16 in an integrated fashion has dual purposes, namely it provides an ideal location to add functionality to the SCBA system 12 and it avoids bulky additions being added to the SCBA system 12 which can be detrimental in the field. The location of the in-line accessory 10, i.e. near the user's mouth, face, etc., in a prime location to locate equipment features while in high stress, low visibility, and low dexterity situations. There is also a general lack of integration of conventional equipment which only adds to the difficulty, but is solved by the integration of the in-line accessory 10 with existing connection techniques. For example, most firefighters currently utilize some version of the Scott Air-Pak SCBA breathing system which features a twist-lock interface between the regulator 16 and the mask 14. The in-line accessory 10 offers an insight to leverage this twist lock interface would be an ideal solution to streamline the gear, put critical feedback devices in their field of view, and place important communication devices within easy reach. Also, the in-line accessory 10 is relevant to other user types beyond firefighters, including HAZMAT, or any use case that requires the use of the regulator 16 and the mask 14 as part of the SCBA system 12 (or a SCUBA system).

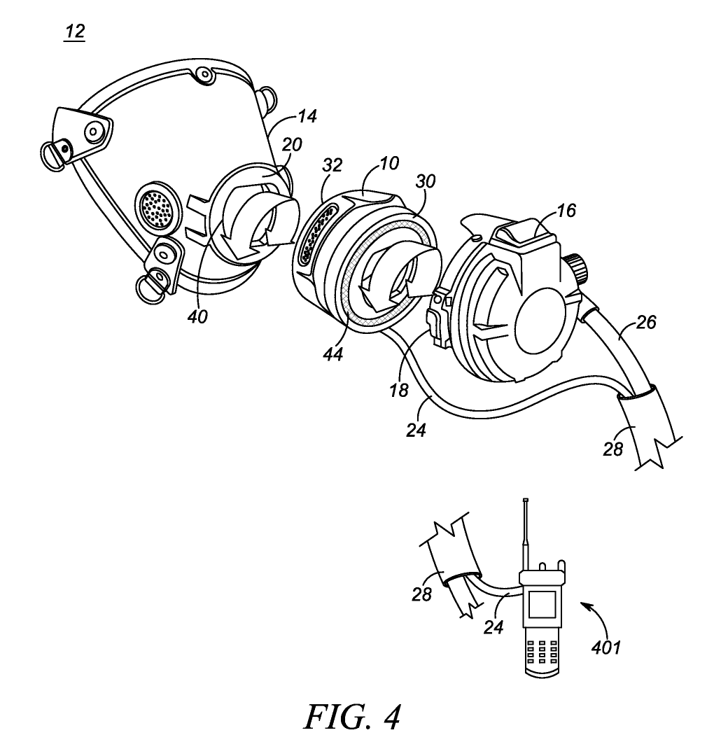

FIG. 4 is a perspective diagram of the SCBA system 12 illustrating connecting the in-line accessory 10 to the mask 14 and the regulator 16 in accordance with some embodiments. Here, in FIG. 4, the SCBA system 12 includes a twist-lock configuration. Other locking configurations are also contemplated. To connect the in-line accessory 10, the in-line accessory 10 can be connected to either the mask 14 or the regulator 16 first via a twist and lock motion. For example, connecting the in-line accessory 10 to the mask 14, the male twist-lock interface 32 is twisted in the female twist-lock interface 20 on the mask 14, and connecting the in-line accessory 10 to the regulator 16, the male twist-lock interface 18 on the regulator 16 is twisted in the female twist-lock interface 30. The twist-lock interfaces 18, 20, 30, 32 operate by twisting in one direction until locked and twisting in an opposite direction until unlocked.

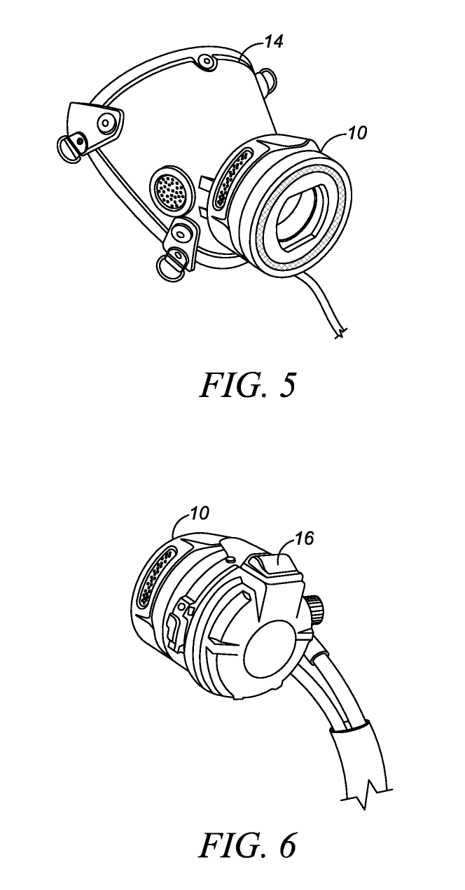

FIGS. 5 and 6 illustrate perspective diagrams of manual locking options for the in-line accessory 10 to the mask 14 (FIG. 5) or to the regulator 16 (FIG. 6) in accordance with some embodiments. Additionally, the in-line accessory 10 could also contain a manual locking mechanism that allows it to be locked to either the mask 14 (FIG. 5) (so the regulator 16 can be twisted off the mask 14 and the in-line accessory 10 and removed for breathing when not using the air tank), or for the in-line accessory 10 to be locked to the regulator 16 so that it can easily be removed along with the regulator 16. Having this option would allow for some flexibility in how it is used. This locking option allows the in-line accessory 10 to be semi-permanently stay attached to either side of the SCBA system 12. For example, the in-line accessory 10 can include a notch lock which can be positioned to semi-permanently lock the in-line accessory 10 to the mask 14 or the regulator 16.

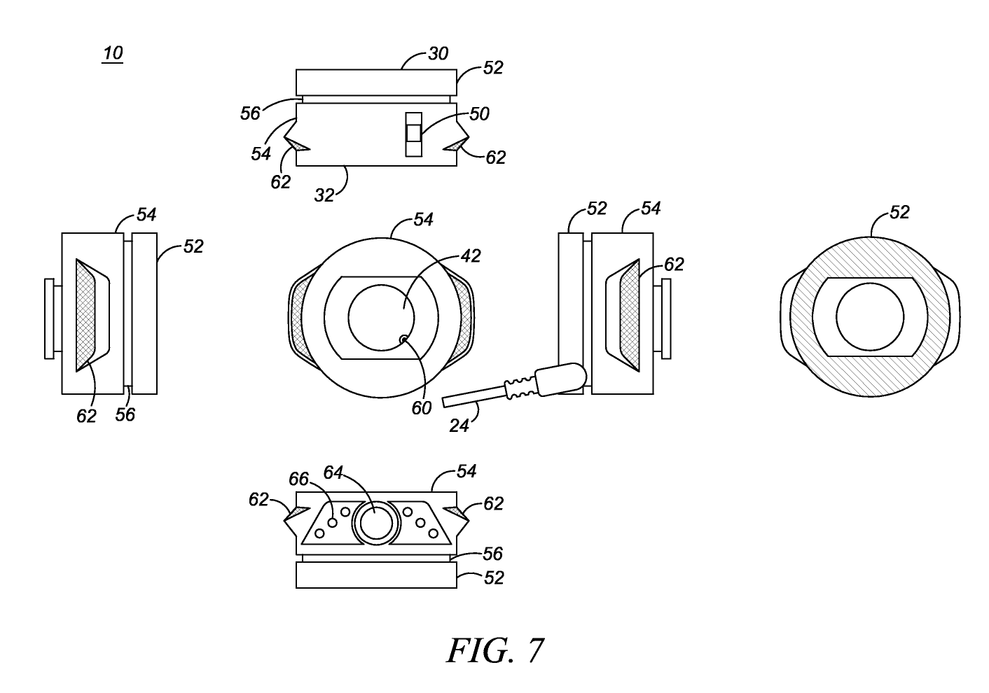

FIG. 7 is a schematic diagram of the in-line accessory 10 as a remote speaker microphone (RSM) in accordance with some embodiments. Specifically, FIG. 7 illustrates various views of the in-line accessory 10 and associated components for operation as an RSM. The in-line accessory 10 can include a lock switch 50, such as, for example, on a top side. The lock switch 50 can be used to implement the manual locking mechanism described above. The lock switch 50 can have three settings—semi-permanent lock of the in-line accessory 10 to the regulator 16, semi-permanent lock of the in-line accessory 10 to the mask 14, and no lock. For example, placed in the middle, as shown in FIG. 7, the lock switch 50 can be in the no lock setting. If the lock switch 50 is moved towards the female twist-lock interface 30, this can lock the in-line accessory 10 to the regulator 16, and if the lock switch 50 is moved towards the male twist-lock interface 32, this can lock the in-line accessory 10 to the mask 14. That is, the lock switch 50 can selectively implement the manual locking mechanism to provide one of a semi-permanent lock of the in-line accessory 10 to the regulator 16, a semi-permanent lock of the in-line accessory 10 to the mask 14, and no lock. The semi-permanent lock enables the in-line accessory 10 to remain attached to one of the mask 14 or the regulator 16 when disconnected in the SCBA system 12.

As an RSM, the in-line accessory 10 leverages the twist-lock interface between the mask 14 and the regulator 16 to add a donut-like form-factor RSM between the mask 14 and the regulator 16. The opening 42 allows air to pass freely though the in-line accessory 10, i.e. between the regulator 16 and the mask 14. Again, the in-line accessory 10 is optimally placed directly in front of the user's mouth —perfectly placed for speech pickup. The in-line accessory 10, as an RSM or the like, can include a two piece design including pieces 52, 54 and an intermediate section 56 therebetween. In an exemplary embodiment, the pieces 52, 54 can be compressed relative to one another with the intermediate section 56. For example, the piece 52 that connects to the regulator 16 and the piece 54 that connects to the mask can compress slightly and click relative to one another, and this can be used as a push-to-talk (PTT) button. That is, the form factor of the in-line accessory 10 can include the pieces 52, 54 and the intermediate section 56 therebetween such that the pieces 52, 54 are compressible relative to one another and compression is utilized for push-to-talk (PTT) activation.

Advantageously, this enables all of the regulator 16 to effectively become the PTT button. This creates a very easy to use PTT interface and, if the user becomes trapped and the user's arms are inoperable, the user could press the mask 14 and/or the regulator 16 to a surface to actuate the PTT to call Mayday.

Again, the in-line accessory 10 includes the female twist-lock interface 30 on one side on the piece 52 and the male twist-lock interface 32 on the other side on the piece 54. The in-line accessory 10 includes at least one microphone 60 which can be located in the opening 42 and at least one speaker 62. Here, the in-line accessory 10 is shown with two speakers 62 located on the sides and angled and directed backward towards the user's ears. The in-line accessory 10 can include the cable connection 24 connected to the piece 52 to provide power/data connectivity. Alternatively, the in-line accessory can be cordless with wireless connectivity and on-board power (battery).

The in-line accessory 10 can include an emergency button 64 which can be pressed to signify an emergency and one or more light emitting diode (LED) lights 66 on the bottom side of the in-line accessory 10. The LED lights 66 are situated to shine light on the user's frontal area to help them see and interact with their gear in darkened environments, free themselves if they become stuck, and also enable others to see them better. Additionally, the in-line accessory 10 could incorporate other features such as biometric monitoring (breathing rate, heart rate, user temperature, etc.) and communicate a user's vitals via their radio/device. The cable connection 24 could be routed along with the air cable 26 via the use of the sheath 28 that would co-locate the cord and hose. Optionally, the user 22 could route the cable connection 24 in a normal fashion through the user's 22 clothing, e.g. down into or through a jacket where a radio is placed. Either solution results in a very short exposed cord length, thereby greatly reducing the chances of the cable connection 24 becoming tangled, snagged, or cut/melted. The cable connection 24 terminates in a radio 401 which can be located on or held by the user. This is shown in FIG. 4. The cable connection 24 serves as a communications link between the in-line device and the radio 401.

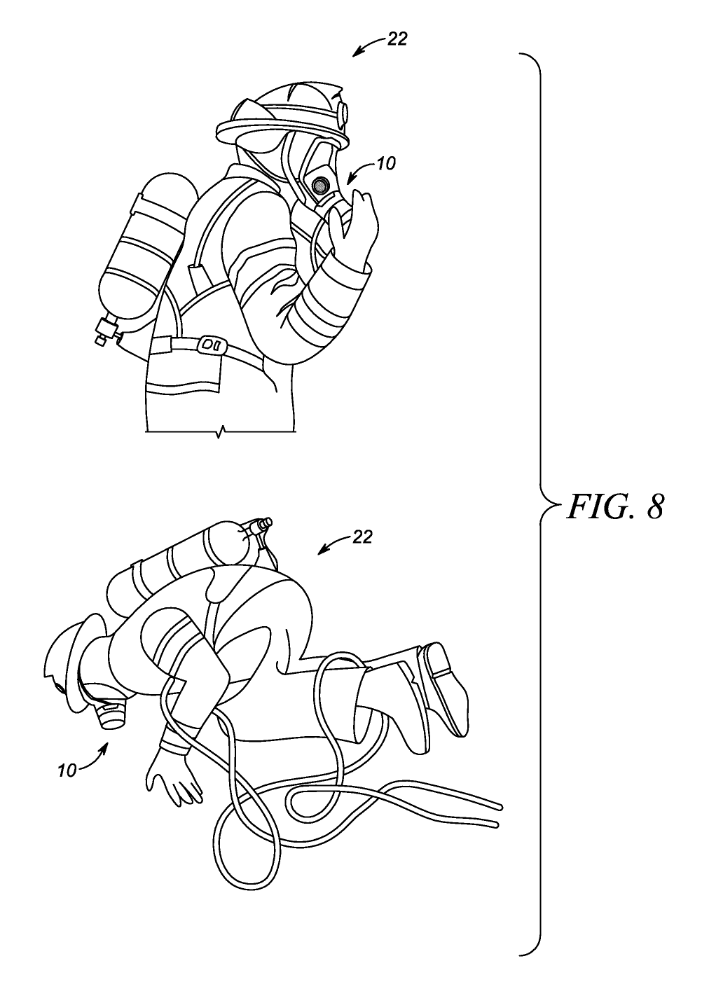

FIG. 8 is a diagram of a user 22 operating the in-line accessory 10 as an RSM with PTT activation in accordance with some embodiments. Again, handheld RSM form factors are not optimized for firefighters and other extreme environment users and do not integrate with well with the SCBA system 12. There are problems with the usability of conventional hand-gripped speaker microphones due to the placement on the chest in a non-visible location while wearing gear. A hanging cord is also a liability and can easily get snagged or tangled in the user's gear when maneuvering in tight areas. The microphone and speaker of a conventional RSM are also not in an ideal location to pick up the user's voice and be heard—especially for this application—hostile environments. This is largely due to the fact that they are wearing the SCBA system 12 with mouths covered by the mask 14, making it difficult to speak into the conventional RSM. Thus, with the SCBA system 12, users struggle to hold the grasp the conventional RSM and hold it close to the exhalation port on the mask 14 where their voice can be heard. The securing clip that holds the conventional RSM to a user's gear is also inadequate for extreme applications due to the friction/drag across a user's gear as he maneuvers through tight quarters. With the aforementioned in mind, the in-line accessory 10 offers the RSM with integration in the SCBA system 12 without obscuring the user's field of view, i.e. the in-line accessory 10 mounts to the existing interface between the mask 14 and the regulator 16 and does not hang off the mask 14 at another location.

In FIG. 8, the user 22, e.g. a firefighter, is shown in two views with the in-line accessory 10 with PTT activation. First, the user 22 can compress and hold the regulator 16 and/or the in-line accessory 10 to activate PTT. Second, if the user 22 is down or hands are unavailable, the user 22 can press the regulator 16 and/or the mask 14 against something to activate PTT. Advantageously, the in-line accessory 10 is able to be activated hands-free in a situation where the user's hands are disabled. Note, in addition to PTT, the in-line accessory 10 can operate as an open microphone, etc. Also, these modes could be configurable.

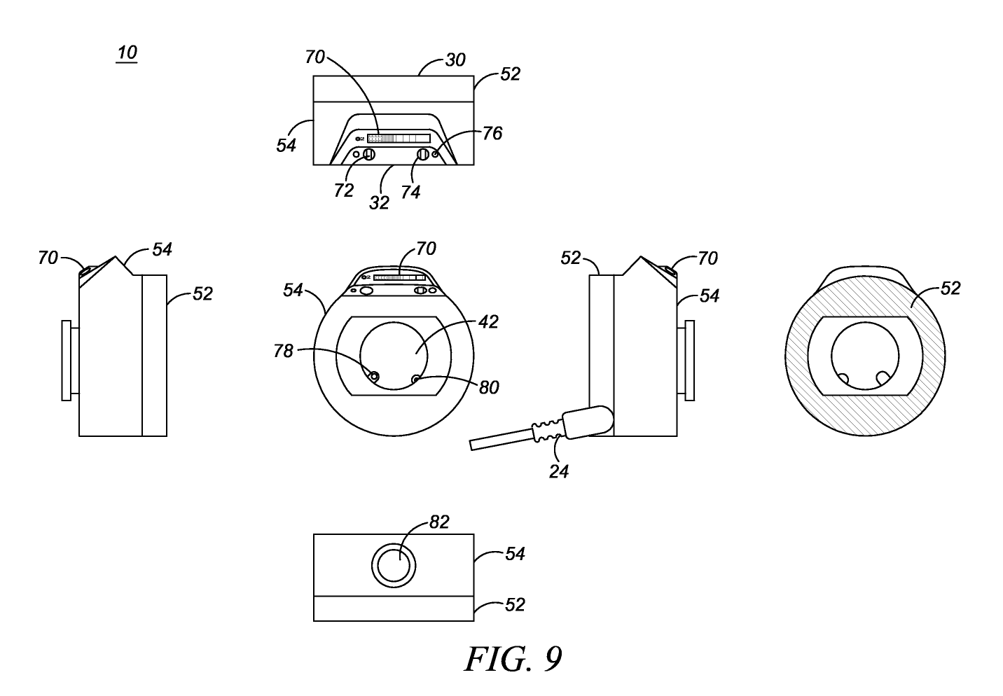

FIG. 9 is a schematic diagram of the in-line accessory 10 as a biometric sensor and the like in accordance with some embodiments. Similar to FIG. 7, FIG. 9 illustrates various views of the in-line accessory 10 and associated components for operation as a sensor. Those of ordinary skill in the art will recognize that the in-line accessory 10 can provide additional functionality besides an RSM or sensor, and these exemplary embodiments are presented herein for illustration purposes. As a sensor, the in-line accessory 10 can include the two pieces 52, 54, but they do not need to compress for PTT (thus, the intermediate section 56 is not necessary). Again, the in-line accessory 10, as a sensor, is a hardware platform/interface that leverages the twist-mount interface between the regulator 16 and the mask 14.

As a sensor, the in-line accessory 10 can be a biometric monitoring system which fastens in between the regulator 16 and the mask 14 in the SCBA system 12 that is commonly worn by personnel working in hazardous environments. The in-line accessory 10 can include the capability to detect real time heart rate, body core/skin temperature, eye blink rate and head tracking for consciousness and respiration rate in real time, and the like. The in-line accessory 10 could also have the capability to display relevant information or warnings to the user 22 and transmit information to command staff or other users, if appropriate. The in-line accessory 10 can also query the user 22 through the display or audio to respond to stimuli, such as “blink your eyes twice” or “take a deep breath,” etc.

The in-line accessory 10 can include a heads-up display 70, a near infrared (IR) camera 72, a red/green/blue (RGB) camera 74, and an illumination LED 76. The in-line accessory 10 can also include a thermal camera 78, a microphone 80, and an emergency button 82. Collectively, the IR camera 72, the RGB camera 74, the illumination LED 76, and the thermal camera 78 can be referred to as a plurality of imaging devices 72, 74, 76, 78 for monitoring biometric information of the user 22. For heart rate, with the RGB camera 74 and the IR camera 72, it is possible to measure slight variations in light absorption which can be mapped to a heart rate. Core/Skin temperature can be measured using a far infrared thermal IR array or a single thermal IR sensor pointing at the face. A few pixels in the thermal array can be used to measure the eye temperature for core temperature measurement. This can be used to measure hyperthermia. The thermal camera can also be positioned to measure the temperature of an object in the firefighter's field of view. The in-line accessory 10 can also include other environmental sensors to monitor physical or environmental conditions, such as temperature, sound, pressure, air quality, etc.

Eye tracking can be determined using the RGB camera 74 and illumination, such as from the illumination LED 76 which is near IR to prevent blinding the user 22. The RGB camera 74 field-of view could include at least one eye to detect blink rate and eyelid state. This could be used to gauge the firefighter's state of consciousness. An accelerometer can also be used to perform head tracking to further aid in consciousness detection. Respiration rate could be detected using the microphone 80 to detect the positive pump triggering noise in the SCBA system 12, it might be possible to detect the approximate breathing rate. Feedback mechanism can be provided through visual or audio messages to optimize breathing rate. Head position and impact can be measured using an accelerometer/gyroscope combination. Since the mask 14 is fixed with respect to the eye, the above measurements becomes less challenging than a standalone device that is not hands free.

When a fireman (or other working in hazardous environments) is injured or incapacitated, it can be difficult for them to communicate their situation to others. Complex and restrictive respiration gear can further compound the problem. Further, there are almost no unobtrusive methods currently available to detect an injury or incapacitation and automatically communicate this information to others. The specialized gear that workers in hazardous environments must wear limits solutions. Thus, the in-line accessory 10 offers a unobtrusive system and method for health monitoring, e.g. dehydration, dangerously high blood pressure, disorientation, etc. Advantageously, the location of the in-line accessory 10 is optimal for such life-monitoring systems—placed at the user's head/face so that sensor information is closely coupled to the bodily features that communicate their vital status (breath, eyes, head position, head temp).

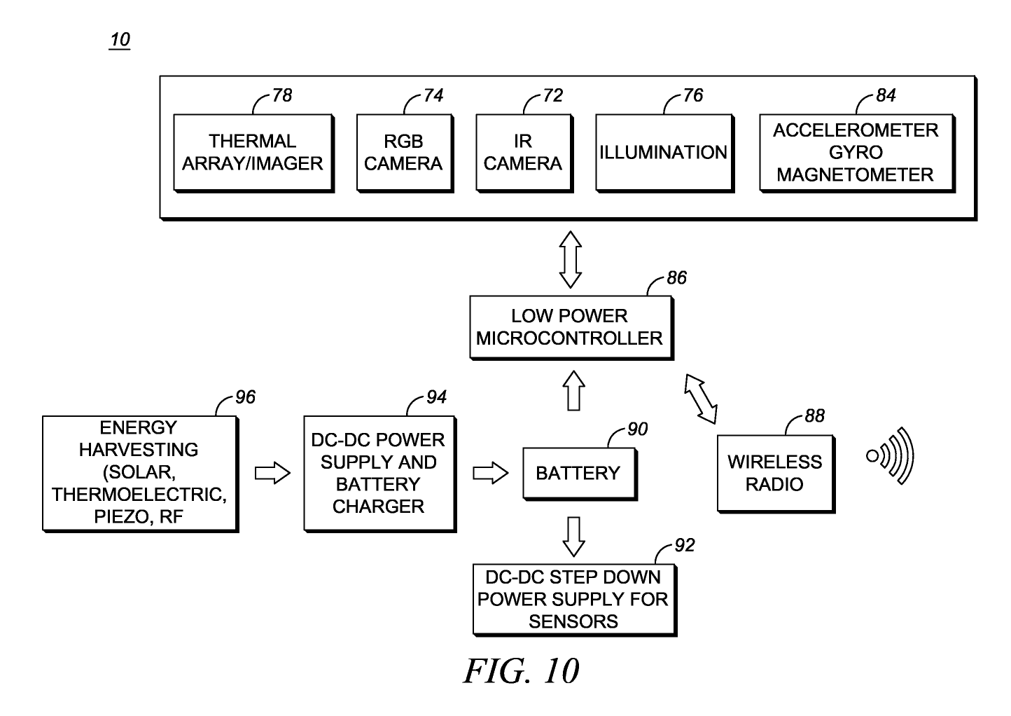

FIG. 10 is a block diagram of an electrical architecture of the in-line accessory 10 as a sensor in accordance with some embodiments. Again, the in-line accessory 10 can include the IR camera 72, the RGB camera 74, the illumination LED 76, the thermal camera 78 which can be a thermal array or imager, and an accelerometer/gyro/magnetometer 84. Each of the aforementioned components 72, 74, 76, 78, 84 can be communicatively coupled to a microcontroller 86 which can be communicatively coupled to a wireless radio 88.

The microcontroller 86 is a hardware device for executing software instructions. The microcontroller 86 can be any custom made or commercially available processor, a central processing unit (CPU), an auxiliary processor among several processors associated with the in-line accessory 10, a semiconductor-based microprocessor (in the form of a microchip or chip set), or generally any device for executing software instructions. When the in-line accessory 10 is in operation, the microcontroller 86 is configured to execute software stored within memory, to communicate data to and from the memory, and to generally control operations of the in-line accessory 10 pursuant to the software instructions. In an exemplary embodiment, the microcontroller 86 may include a mobile optimized processor such as optimized for power consumption and mobile applications.

The wireless radio 88 enables wireless communication to an external access device or network. Any number of suitable wireless data communication protocols, techniques, or methodologies can be supported by the wireless radio 88, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication.

The in-line accessory 10 can also include a battery 90, a DC-DC step down power supply 92 for the sensors, a DC-DC power supply and/or battery charger 94, and optionally an energy harvester 96. The battery 90 can power the microcontroller 86 and the wireless radio 88 and the various components 72, 74, 76, 78, 84 via the DC-DC step down power supply 92. The DC-DC power supply and/or battery charger 94 can charge the battery 90 from an external power source as well as from the energy harvester 96 which can be solar, thermoelectric, piezoelectric, RF, etc.

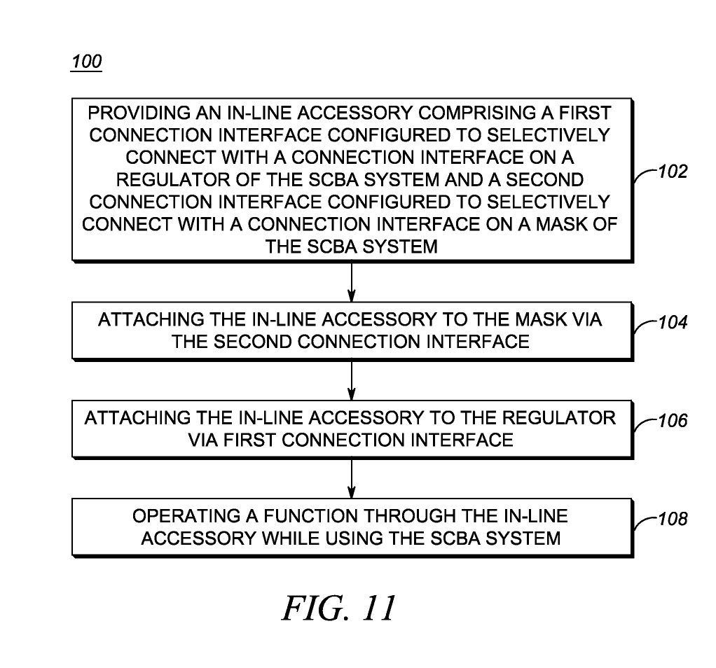

FIG. 11 is a flowchart of an in-line accessory method 100 for integration with a self-contained breathing apparatus (SCBA) system in accordance with some embodiments. The in-line accessory method 100 includes providing an in-line accessory comprising a first connection interface configured to selectively connect with a connection interface on a regulator of the SCBA system and a second connection interface configured to selectively connect with a connection interface on a mask of the SCBA system (step 102); attaching the in-line accessory to the mask via the second connection interface (step 104); attaching the in-line accessory to the regulator via first connection interface (step 106); and operating a function through the in-line accessory while using the SCBA system (step 108); wherein the in-line accessory is disposed between the regulator and the mask in a non-obtrusive manner in the SCBA system.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. An in-line accessory (10) for use with a self-contained breathing apparatus (SCBA) system (12), comprising:
a hardware form factor comprising an opening (42);
a first connection interface (30) on the hardware form factor configured to selectively connect with a connection interface on a regulator (16) of the SCBA system (12);
a second connection interface (32) on the hardware form factor configured to selectively connect with a connection interface on a mask (14) of the SCBA system (12); and
circuitry disposed on and/or within the hardware form factor to perform and add one or more functions to the SCBA system (12);
wherein the hardware form factor is disposed between the regulator (16) and the mask (14) in a non-obtrusive manner in the SCBA system (12) and the opening (42) supports air flow from the regulator (16) to the mask (14).

2. The in-line accessory (10) of claim 1, wherein the first connection interface (30) and the second connection interface (32) comprise twist-lock interfaces.

3. The in-line accessory (10) of claim 1, wherein the first connection interface (30) is substantially the same as the connection interface on the mask (14) and the second connection interface (32) is substantially the same as the connection interface on the regulator (16) thereby enabling the in-line accessory (10) to connect with the SCBA system (12).

4. The in-line accessory (10) of claim 3, further comprising:
a seal (44) on the first connection interface (30) forming an air-tight barrier between the in-line accessory (10) and the regulator (16); and
a seal on the second connection interface (32) forming an air-tight barrier between the in-line accessory (10) and the mask (14).

5. The in-line accessory (10) of claim 1, further comprising:
a cable connection (24) connected to the in-line accessory (10) for data and/or power, wherein the cable connection (24) is one of routed in a sheath (28) with an air cable (26) to the regulator (16) or routed in clothing of a user (22).

6. The in-line accessory (10) of claim 1, further comprising:
a lock switch (50) for selectively implementing a manual locking mechanism to provide one of a semi-permanent lock of the in-line accessory (10) to the regulator (16), a semi-permanent lock of the in-line accessory (10) to the mask (14), and no lock, wherein the semi-permanent lock enables the in-line accessory (10) to remain attached to one of the mask (14) or the regulator (16) when disconnected in the SCBA system (12).

7. The in-line accessory (10) of claim 1, wherein the circuitry performs the one or more functions comprising any of a remote speaker microphone, a biometric sensor, an environmental sensor, a rollover detection system, a heads up display, and an indoor locationing system.

8. The in-line accessory (10) of claim 1, wherein the circuitry performs the one or more functions comprising a remote speaker microphone, wherein the hardware form factor comprises pieces (52, 54) and an intermediate section (56) therebetween such that the pieces (52, 54) are compressible relative to one another and compression is utilized for push-to-talk (PTT) activation.

9. The in-line accessory (10) of claim 1, wherein the circuitry comprises a plurality of imaging devices (72, 74, 76, 78) for monitoring biometric information of the user (22).

10. A self-contained breathing apparatus (SCBA) system (12), comprising:
a mask (14) comprising a first connection interface (20);
a regulator (16) comprising a second connection interface (18), wherein the first connection interface (20) is configured to connect with the second connection interface (18); and
an in-line accessory (10) comprising a third connection interface (32) configured to selectively connect with the first connection interface (20) and a fourth connection interface (30) configured to selectively connect with the second connection interface (18), wherein the in-line accessory (10) is selectively disposed between the mask (14) and the regulator (16) to add one or more functions to the SCBA system (12), wherein air flows between the regulator (16) and the mask (14) via an opening (42) in the in-line accessory;
wherein the in-line accessory (10) is disposed between the regulator (16) and the mask (14) in a non-obtrusive manner in the SCBA system (12).

11. The SCBA system (12) of claim 10, wherein the first connection interface (20), the second connection interface (18), the third connection interface (32), and the fourth connection interface (30) comprise twist-lock interfaces.

12. The SCBA system (12) of claim 10, wherein the fourth connection interface (30) is substantially the same as the first connection interface (20) and the third connection interface (32) is substantially the same as the second connection interface (18).

13. The SCBA system (12) of claim 10, further comprising:
a cable connection (24) connected to the in-line accessory (10) for data and/or power, wherein the cable connection (24) is one of routed in a sheath (28) with an air cable (26) to the regulator (16) or routed in clothing of a user (22).

14. The SCBA system (12) of claim 10, further comprising:
a lock switch (50) for selectively implementing a manual locking mechanism to provide one of a semi-permanent lock of the in-line accessory (10) to the regulator (16), a semi-permanent lock of the in-line accessory (10) to the mask (14), and no lock, wherein the semi-permanent lock enables the in-line accessory (10) to remain attached to one of the mask (14) or the regulator (16) when disconnected in the SCBA system (12).

15. The SCBA system (12) of claim 10, wherein the circuitry performs the one or more functions comprising any of a remote speaker microphone, a biometric sensor, an environmental sensor, a rollover detection system, a heads up display, and an indoor locationing system.

16. The SCBA system (12) of claim 10, wherein the circuitry performs the one or more functions comprising a remote speaker microphone, wherein the hardware form factor comprises pieces (52, 54) and an intermediate section (56) therebetween such that the pieces (52, 54) are compressible relative to one another and compression is utilized for push-to-talk (PTT) activation.

17. The SCBA system (12) of claim 10, wherein the circuitry comprises a plurality of imaging devices (72, 74, 76, 78) for monitoring biometric information of the user (22).

18. An in-line accessory (10) method for integration with a self-contained breathing apparatus (SCBA) system (12), comprising:
providing an in-line accessory (10) comprising a first connection interface (30) configured to selectively connect with a connection interface on a regulator (16) of the SCBA system (12) and a second connection interface (32) configured to selectively connect with a connection interface on a mask (14) of the SCBA system (12);
attaching the in-line accessory (10) to the mask (14) via the second connection interface (32);
attaching the in-line accessory (10) to the regulator (16) via first connection interface (30); and
operating a function through the in-line accessory (10) while using the SCBA system (12);
wherein the in-line accessory (10) is disposed between the regulator (16) and the mask (14) in a non-obtrusive manner in the SCBA system (12).
